(19) United States
(12) Patent Application Publication
(10) Pub. No.: US 2026/0002331 A1
(43) Pub. Date: Jan. 1, 2026

(54) SPACE ANCHORS FOR USE ON THE MOON, MARS AND OTHER EXTRATERRESTRIAL BODIES

(71) Applicants: Hamed NIROUMAND, Tehran (IR); Lech Balachowski, Gdansk (PL)

(72) Inventors: Hamed NIROUMAND, Tehran (IR); Lech Balachowski, Gdansk (PL)

(21) Appl. No.: 19/332,033

(22) Filed: Sep. 17, 2025

Related U.S. Application Data
(63) Continuation-in-part of application No. 18/369,145, filed on Sep. 16, 2023.

(51) Int. Cl. E02D 5/80; B33Y 70/00; B33Y 80/00; B64G 99/00; E02D 27/32

(52) U.S. Cl. CPC E02D 5/801; B64G 99/00; B33Y 70/00; B33Y 80/00; E02D 27/32

(57) ABSTRACT

A space anchor, as a simple type of space foundation intended for use on an extraterrestrial body, comprises at least one anchoring part connected to a driving part via a connecting element. The driving part is designed to install the anchoring part at the desired position within the lunar or Martian regolith, also referred to as lunar soil, under space geotechnical conditions that involve different gravitational forces compared to Earth's. Additionally, the driving part enables connection to an external structure as part of space construction on the extraterrestrial body. Both the anchoring and connecting parts are manufactured from a polymer using 3D or 4D printing technology.

### BACKGROUND OF THE INVENTION

### Field of the Invention

The present disclosure generally relates to the lunar or Martian regolith, also referred to as lunar soil, under space geotechnical conditions that involve different gravitational forces compared to Earth's, space exploration industry and construction engineering use on extraterrestrial bodies, and more particularly to mechanical space anchors, new materials and construction technique used for their production and a method of production thereof.

### Brief Description of the Background of the Invention Including Prior Art

As space exploration becomes a dominant scientific and technological goal worldwide, many challenges appear, many of which relate to simple and durable construction solutions applied on-site at the extraterrestrial body, for example Moon or Mars.

Since large-scale transport of the construction equipment outside the Earth's surface and orbit poses a significant economical challenge, other solutions are begin seek, such as on-site manufacturing of the construction equipment on the extraterrestrial body. In that case, the building material can be delivered externally e.g. from Earth economically in bulk, i.e. minimizing the volume required for transport of the material.

Developing a construction project always requires providing adequate stability and support, without which the structure, subject to environmental stress as well as its own weight, is prone to falling apart. As a typical construction project requires a stable and robust foundation and a durable support of its structure, a field of relatively low-weight, either permanent or temporary structures exists, which typically does not need a standard, extensive foundation to be prepared before its construction. This particularly applies on an extraterrestrial body such as Moon or Mars, where the amount of available building material is extremely limited by the transportation costs or by the on-site material availability, its suitability for processing and by availability of the equipment required for such processing.

The lunar or Martian regolith, also referred to in the case of the Moon as lunar soil, is a layer of loose, fragmented material that covers the solid bedrock of the Moon and Mars. This regolith consists of particles ranging from fine dust to larger rock fragments and is formed through prolonged exposure to meteoroid impacts, solar wind, and other space weathering processes.

Unlike terrestrial soil, lunar and Martian regolith lack organic matter and water, resulting in a dry, angular, and highly abrasive particulate structure. The term “regolith” is preferred in planetary science to emphasize the inorganic, extraterrestrial nature of this surface layer.

When interacting with this material in the context of construction, excavation, or anchoring systems, it is essential to consider space geotechnical conditions, which refer to the mechanical and physical behavior of soil under the environmental conditions found in space or on celestial bodies. These include:
Reduced gravitational acceleration (approximately ⅙th of Earth's on the Moon and about 0.38 g on Mars),
Low atmospheric pressure or vacuum, particularly on the Moon,
Extreme temperature fluctuations,
Electrostatic charging of dust particles,
And the absence of biological or chemical processes that commonly affect soil behavior on Earth.

These factors significantly influence regolith behavior, such as bearing capacity, compaction, shear strength, and penetration resistance. Space geotechnics must be carefully accounted for in the design of extraterrestrial infrastructure.

Such structures include tents, scientific apparatus, retaining walls, guyed masts, utility posts, pipelines, subsided areas with subsidence and sinkhole, land subsidence or space subsidence such as Mars/Moon subsidence, and many others. Such structures, often designed to withstand by itself only a vertical stress resulting from their own weight, depend on ground-based guy lines in order to provide the support needed for the construction not to collapse. Typically, one end of the guy line is attached to the structure and the other to an anchor, placed in ground. As the guy lines are subject to great loads resulting from the often significant heights of the structures they support, the anchors need to hold on firmly to the ground.

Anchors are primarily designed and constructed to resist outwardly directed loads imposed on the foundation of a structure. There are few different kinds of the anchors known, but the purpose of all of them is the same. Anchors are divided into two types: 1) grouting anchors, 2) mechanical anchors.

Geopolymer can be used as grouting in space anchors. Geopolymer is a type of inorganic binder that can be synthesized from industrial by-products, such as fly ash and slag. Geopolymer has many advantages over conventional cement-based grouts, such as high strength, low shrinkage, good durability, and environmental friendliness.

Examples of the mechanical anchors are: anchor plates, anchor screws or helical anchors and irregular shaped anchors as keying anchors. Anchor plates play an important role in the design of structures such as for example: seawalls, transmission towers, tunnels, buried pipelines, and retaining walls. Design and construction of the lunar soil anchor plates focuses on the various theories based on the design and construction techniques of anchor plates in lunar soil mechanics as space geotechnics. Anchor plates can have various shapes, like for example: square, rectangular, strip and circular shapes. Existing earth anchors are produced mainly from steel or galvanized metal materials. Apart from the materials used, the shape of the anchor and the method of attachment into the ground define how well the anchor will support the guy-lined structure and how fast the construction process can proceed. Many methods of attachment of an earth anchor into the ground exists and results from the anchor design. For example, a helical or screw earth anchor includes a helix around its longitudinal extension, which allows for an easy screwing of the anchor into the ground and attaching the guy line. Another type of an earth anchor is a keying anchor, which is characterized by its specific design, allowing it to be easily inserted into the ground with the guy line attached. After the insertion is done, the guy line is pulled, which makes the anchor body rotate and lock inside the ground, providing a support for the guy-lined structure. One of the subtype of the keying anchors is an earth plate anchor. Its shovel-like design facilitates the insertion process and, because of its simplicity, is not hard and expensive to produce.

Another factor to consider in case of earth anchors is the material used for the construction of the device. Various commercial types of steel keying anchors, such as “duckbill” or “mantaray” are known. Steel is a popular choice as a construction material for earth anchors, because of its high strength, durability, availability and ease of production. However, in terms of steel earth anchors, corrosion is a significant concern, because of the soil moisture due to water or water ice and salinity, which degrade the mechanical properties of the steel over time. This can be resolved by using a stainless steel or other non-corrosive metals, with a disadvantage of much higher material cost.

WO1990008877A1 discloses an anchor bolt of oriented polymer having an outer layer of isotropic polymer in which a multiplicity of radial ribs or a helical thread is formed, with the ribs/thread having an angle of inclination with respect to the longitudinal axis of the bolt of less than about 10°. The disclosed anchor, because of the use of the polymer as the building material, provide very high structural integrity of the anchor while being immune to the corrosive effect of the saturated soil. However, as the anchor is a helical type, it suffers from a typical disadvantage of this kind of earth anchors, which is a specific soil characteristics, which allow for the use of such an anchor. While a compact and uniform soil will allow for a helical anchor to be screwed inside easily, a loose ground of a varied composition, including stones and other obstacles, will constitute a challenge for this type of an earth anchor.

CN207419467 discloses an earth anchor for municipal works. The anchor comprises multiple ground anchor rods, each provided with a connecting ring, and a ground anchor tip. A spiral blade is arranged on the bottom outer side wall of each bolt. The spiral blade further includes a connecting plate, a left connecting rod, a right connecting rod and a fixing nut. As the assembly comprises multiple helical-type earth anchors, it provides an improved pull-out strength capabilities without complex design changes, which greatly benefits the production costs. However, the helical type anchors may require sophisticated equipment necessary to screw the anchor into the ground, especially in case of an anchor comprising multiple screws, needing more power than a single-screw anchor, particularly when a hard, compact soil is being accessed.

U.S. Pat. No. 3,282,002A discloses a keying device for embedment anchor. The anchor includes tip and tail sections, interconnected pivotally with each other. The anchor includes a loop in a tail section providing means for attaching the anchor cable to the anchor body. The anchor, after insertion into the ground and application of force from the anchor cable, performs an underground rotation after its fin section is pushed into the ground above. The anchor rotates away from its position substantially parallel to the anchor cable, providing a maximum resistance to withdrawal from the earth. Such a distribution of the anchor body into two separate sections connected pivotally provides an easier rotation underground but also requires more sophisticated production process, as parts such as hinges and pins are required. Also, corrosion must be considered, as complex designs often depend more on the strength of its building material than simpler designs.

All of the above presented earth anchors known from the prior art must be produced in advance before providing them to the specific construction site on an extraterrestrial body. As the costs involved in extraterrestrial transportation are prohibitive, an extensive optimization of the supply chain of an extraterrestrial construction project is key for its viability. Additionally, if a shortage or damage of a certain part or equipment piece occurs in case of a construction project on an extraterrestrial body, the time required to deliver a replacement from Earth can reach 7-9 months and incur huge additional costs. This can be avoided by providing a surplus of the materials and equipment but that in turn increases the volume and mass of the extraterrestrial transportation which is also not desired.

In addition, the material of the anchors is usually a galvanized steel, which is more expensive and heavier as compared to other materials, for example polymers. The steel and also the galvanized steel are not resistant enough to a salty environment.

### SUMMARY OF THE INVENTION

### Purposes of the Invention

It is an object of the present invention to provide space anchors, in this application also called extraterrestrial soil anchors, Moon anchors, Lunar anchors or Mars anchors, for an extraterrestrial use which will overcome the above specified drawbacks of the anchors known from the prior art. The space anchor uses in lunar or Martian regolith, also referred to as lunar soil, under space geotechnical conditions that involve different gravitational forces compared to Earth's. The filament materials and manufacturing technology are designed to accommodate the varying gravitational forces as well as the distinct environmental and humidity conditions of the Moon and Mars compared to those of Earth.

The space anchors are usable or can be used for anchoring lunar or Martian habitats, rovers, solar panels, or other equipment to the surface, especially in areas with high winds, dust storms, or seismic activity. The space anchors are also usable or can be used for anchoring cables or tethers for lunar or Martian space elevators, which are proposed transportation systems that use a long cable to connect the surface with a docking port in orbit. The space anchors are also usable or can be used for anchoring parachutes or balloons for aerobraking, which is a technique that uses atmospheric drag to slow down a spacecraft and reduce its orbital velocity.

In particular, it is an object of the present invention to provide space anchors which are significantly cheaper, are completely resistant to the salty environment and other atmospheric factors, and also can be manufactured on the specific construction site on an extraterrestrial body without the surplus, exactly according to the dimensions and other specific features required on the construction site, without delay. In this application the wording “space anchors” means the anchors known on Earth as earth anchors, which are usable or can be used on an extraterrestrial bodies to anchor any object, device or equipment to the surface or lunar or Martian regolith, also referred to as lunar soil, under space geotechnical conditions of the extraterrestrial body.

These and other objects and advantages of the present invention will become apparent from the detailed description, which follows.

### BRIEF DESCRIPTION OF THE INVENTION

The object of the invention is space anchors for use or usable on an extraterrestrial body, comprising at least one anchoring part connectable or connected by a connecting part to a driving part for installing the anchoring part in the desired position in the lunar or Martian regolith, also referred to as lunar soil, under space geotechnical conditions that involve different gravitational forces compared to Earth's and for connecting to an external structure (not claimed), wherein the anchoring part is connectable or connected on its distal end to the anchoring part, and on the proximal end is connectable to an external driving device or to the external structure or designed for receiving a force, for example created by a hitting device, or just for placing the anchor in the desired position in the lunar or Martian regolith, also referred to as lunar soil, under space geotechnical conditions that involve different gravitational forces compared to Earth's. The anchoring part and the connecting part are manufactured of polymer. The driving part can be made of polymer or metal, for example steel or aluminum. The polymer includes a Polycarbonate (PC), a Nano-Polymers, a Bio-Polymers, Nano-Bio Polymers, Nano-Bio Filaments or Bio-Filaments. The polymer material is provided in a form of a filament wound on a exchangeable spool, or placed in a cartridge, suitable to be loaded to a 3D or 4D printer as an input material and used for the 3D/4D printing of any designed shape, according to a computer program entered to the control device of the 3D/4D printer. The anchoring part and the connecting part is produced on a 3D/4D printer by using a polymer filament designed as a material for printing on the 3D/4D printer. All usable shapes and sizes of all the parts of the space anchors according to this invention can be stored in the memory of the storage medium of the 3D/4D printer or they can be loaded to the 3D/4D printer from an external memory medium like a USB pen drive, a smartphone or similar, or can be loaded from any Internet site using a WiFi connection or a wire connection. The 3D/4D printers and the polymer filaments used by the 3D/4D printers are well known in the art and they are not an object of the invention. The polymer filaments are standard filaments available on the market, therefore they can be used for any shape to be printed on the 3D/4D printer. If there is an excess left, they are not thrown away after the project is finished, instead they can be used for another project without any waste of the material. All the parts of the space anchors printed on the 3D/4D printer can be assembled using simple tools, or can be even assembled by hand, without using any tools or are manufactured as one piece and do not require assembly at all. All of the parts of the space anchor are dimensioned according to the specific requirements of the construction site and the forces which will act on the specific space anchor. The space anchors can be utilized for numerous applications within various industries, including agriculture, growers, fencing, trellis, mining, geotextiles, landscaping and civil. Various projects need to different bearing capacity or uplift loading. Various types of the space anchors are used in horizontal, vertical and inclined positions because they are used for various applications in building industry and infrastructures. Preferably, the space anchor is manufactured in a form of a plate anchor, wherein the anchoring part is a substantially flat plate in a shape of a circle or square or rectangle or polygon, or any other irregular shape depending on the construction site requirements. The anchoring part is connected substantially perpendicular to the driving part, which in this case is the anchor rod, pivotally or permanently by the connecting part. In case of the permanent connection, the driving part in a form of anchor rod can be connected to the anchoring part by a screw connection. In this case there is a hole provided substantially in the middle of the anchoring part, one end of the anchor rod is threaded and passes through the hole, and the anchor rod is fixed in relation to the anchoring part by nuts from both sides of the anchoring part. The anchor rod can be made of steel or fibre-reinforced plastic (FRP). In case of the pivotal connection, the connecting part is preferably a pivot or joint matching the hub of the anchoring part with a loose fit. The plate space anchor comprises the polymer plate. The plate anchor when attached to the anchor rod has the configuration of a cross with the space cleats facing toward the structure such as transmission towers, retaining walls, etc. The plate space anchor is placed to suitable embedment ratio into the lunar or Martian regolith, also referred to as lunar soil, under space geotechnical conditions that involve different gravitational forces compared to Earth's. The embedment ratio=L/D, where L means embedment length, and D means the anchor width/diameter. The space plate anchors need excavation and backfill. The advantage of the pivotal connection is that after the backfill the angle of the anchor rod in relation to the construction facility can be adjusted. Preferably, the space anchor is provided in a form of a screw anchor known also as a helical anchor, a helical pile or helical pier. The helical anchor can include a single helix or a multi-helix as the anchoring parts. In another words, each of the anchoring part is at least a part of a helical screw connected permanently to the driving part by the connecting part. The anchoring part, the connecting part and the driving part are manufactured as one piece on a 3D/4D printer. The helical anchor is a foundations base system that is made up of helically shaped polymer plates which are permanently attached to a polymer beam which is the driving part. The polymer plates' thickness, number, helices, and diameter standing are dependent on the controlled or supported structure design life, the environmental corrosion and geotechnical parameters, and also the design load demands. The screw anchor can include one, two, three or more separate anchoring parts, or the anchoring parts can be connected and made as one piece. The helical anchors are set up into the space utilizing the driving part in a form of a rotary attachments fitted to space-moving equipment. Because of this, they do not need substantial excavation operations. Resistance is offered by the plates when they have progressed to a depth. The load is then transferred by them. In one embodiment the anchoring part is a helical screw connected permanently to the body part by the connecting part, wherein the helical screw, the body part and the connecting part are manufactured as one piece on the 3D/4D printer in one printing process. Preferably, the space anchor is in a form of a keying anchor, comprising an essentially elongated anchoring part, having a leading end and a trailing end, a longitudinal axis extending from the leading end to the trailing end, a blind bore extending approximately to the middle of the anchoring part between the leading end and the trailing end, along the longitudinal axis from the trailing end of the anchoring part, a through hole provided on the connecting part, positioned substantially in the middle of the anchoring part between the leading end and the trailing end, and a sharp leading part projecting from the leading end of the anchoring part, the leading end being formed as a tapering top reinforced by the distal end of the anchoring part. The anchoring part and the connecting part are manufactured as one piece on the 3D printer. In one embodiment the space anchor is provided in a form of a flat keying anchor comprising an essentially flat anchoring part. In one embodiment the space anchor is provided in a form of a cylindrical keying anchor comprising an essentially cylindrical anchoring part. The driving part can include two members, first member for driving the keying anchor into the lunar or Martian regolith, also referred to as lunar soil, under space geotechnical conditions that involve different gravitational forces compared to Earth's and a second member for actuating the anchoring part by pulling up, which move turns the anchoring part substantially perpendicular to the longitudinal direction of the second member and to the applied load during operation. The through hole is designed for receiving a pin fixed in a clamp at the distal end of the second member of the driving part and forming a joint, and the second member is designed for actuating the keying anchor after it is positioned in the required place. The leading end is tapered towards the distal end of the anchoring part, while the tailing end is provided with an axial blind bore for receiving the first member of the driving part. The anchoring part and the connecting part are manufactured as one piece from polymer on the 3D/4D printer. The keying anchors are substantially vertical driven into the lunar or Martian regolith, also referred to as lunar soil, under space geotechnical conditions that involve different gravitational forces compared to Earth's as the extraterrestrial body by the first member of the driving part and the anchoring part is pulled by the driving part or by the second member of the driving part, connected with the clamp and the pin on its distal end to the through hole being the connecting part and forming a joint, to a substantially horizontal position, increasing pressure and load capacity of the keying anchor. An advantage of the keying anchoring is minimizing the lunar soil disturbance with no digging or moving the lunar soil of the extraterrestrial body. The keying anchors does not disturb the structure of the formation, they may be used in different types of the lunar or Martian regolith, also referred to as lunar soil, under space geotechnical conditions that involve different gravitational forces compared to Earth's. The anchoring system is buried and sealed without the use of cement paste. The keying anchors are environmentally friendly. They does not require any drilling equipment, the installation is simple using standard tools. The installation does not require excessive manpower.

Another object of the present invention is a method of production of the space anchors on an extraterrestrial body, wherein the anchoring part and the connecting part are produced on a 3D/4D printer by using a polymer filament designed as a material for printing on the 3D/4D printer. Any 3D/4D printer available on the market can be delivered by a space ship to the desired place on the extraterrestrial body and be used for this purpose. The energy to power the 3D/4D printer is provided by solar panels. The production of the space anchors on the extraterrestrial body is or can be performed automatically by robots without commitment or work of humans. This way the mission or required presence of any astronauts in the desired place on the extraterrestrial body could be limited to a minimum. The 3D/4D printers for printing objects using a polymer filament are known and there is no need to describe them in detail. FIG. 11 shows an example of such 3D/4D printer.

### BRIEF DESCRIPTION OF THE DRAWINGS

These aims together with other objects and advantages which will become subsequently apparent reside in the details of construction and operation as more fully hereinafter described and claimed, reference being made to the accompanying drawings forming a part hereof, wherein the same numerals refer to the same parts throughout.

In drawings

FIG. 1a-1b show schematically different embodiments of the plate anchors,

FIG. 2a-2b show schematically another embodiments of the plate anchors,

FIG. 3a-3c show perspective view of different embodiments of the screw anchors,

FIG. 4 is a side view of the screw anchor from FIG. 3a,

FIG. 5 is a top view of the screw anchor from FIG. 3a,

FIG. 6 is a perspective view of the flat keying anchor,

FIG. 7 is a side view of the keying anchor from FIG. 6,

FIG. 8 is a top view of the keying anchor from FIG. 6,

FIG. 9 is a perspective view of the flat keying anchor shown with the two members of the driving part,

FIG. 10 is a perspective view of the cylindrical keying anchor,

FIG. 11 shows an example of a 3D/4D printer for printing with a polymer filament.

### DETAILED DESCRIPTION OF INVENTION AND PREFERRED EMBODIMENT

In describing a preferred embodiment of the invention illustrated in the accompanying drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

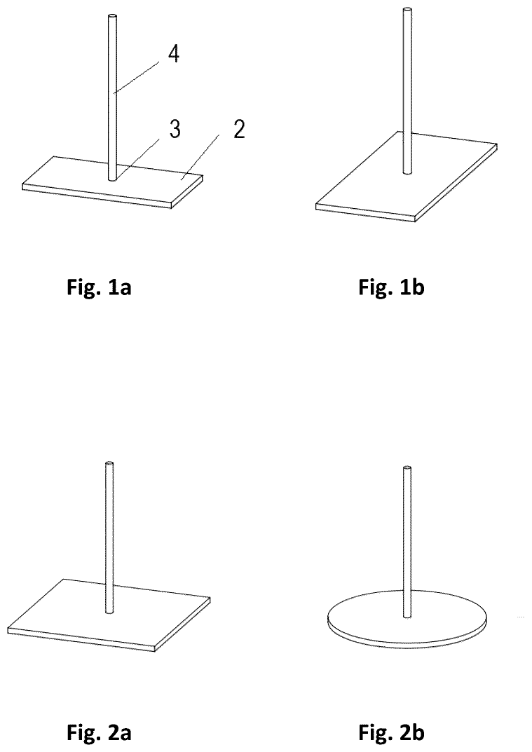

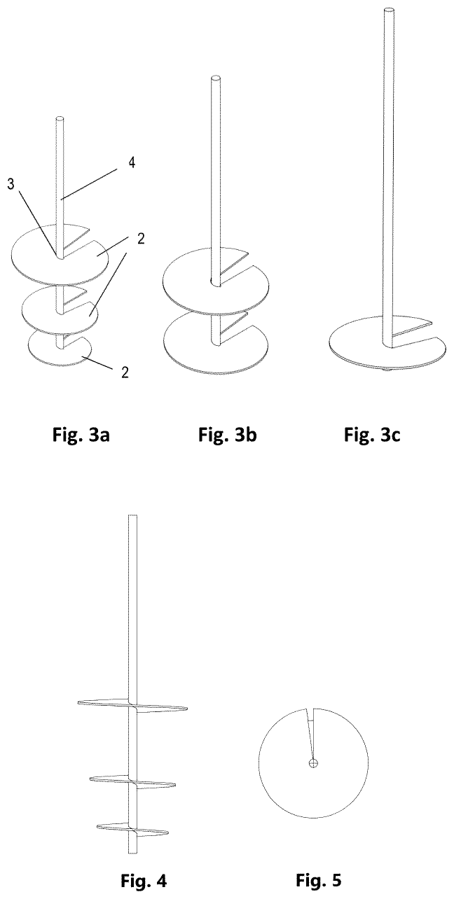

Referring to the drawing, FIG. 1a, FIG. 1b, FIG. 2a and FIG. 2b schematically show different embodiments of the plate-type anchors (known as plate anchors). FIG. 1a shows a strip-type anchor, FIG. 1b shows a rectangular-type anchor, FIG. 2a shows a square-type anchor and FIG. 2b shows a circular-type anchor. All the shapes refer to the shape of the anchoring part 2, which is connected by a connecting part 3, integrated as one part with the driving part 4. The connecting part 3 is reinforced connection between the anchoring part 2 and the connecting part 3, created by additional polymer material similar to an angle weld around the joint. All parts of the different embodiments of the plate anchors are manufactures from the polymer as one part on the 3D/4D printer.

FIG. 3a, FIG. 3b and FIG. 3c schematically show different embodiments of the screw-type anchors (known as screw anchors). FIG. 3a shows the screw anchor with three anchoring parts 2 shaped as a parts of a helical screw. Looking from top to the bottom of the screw anchor (when installed in the lunar or Martian regolith, also referred to as lunar soil, under space geotechnical conditions that involve different gravitational forces compared to Earth's), the top anchoring part is the biggest one (as looking on the diameter), the bottom anchoring part is the smallest one and the diameter of the middle anchoring part is in between of the diameter of the top and the bottom anchoring part. It allows easier installation to the ground. As shown on FIG. 3a, three anchoring parts 2 are connected to the driving part 4 by the connecting part 3. The connecting part 3 is reinforced connection between the anchoring part 2 and the connecting part 3, created by additional polymer material similar to an angle weld around the joint. All parts of the different embodiments of the screw anchors are manufactures from the polymer as one part on the 3D/4D printer. FIG. 4 shows the side view of the screw anchor presented on FIG. 3a, and FIG. 5 shows the top view of the screw anchor presented on FIG. 3a. The corresponding views of the screw anchors from FIGS. 3b and 3c are similar, therefore they are omitted.

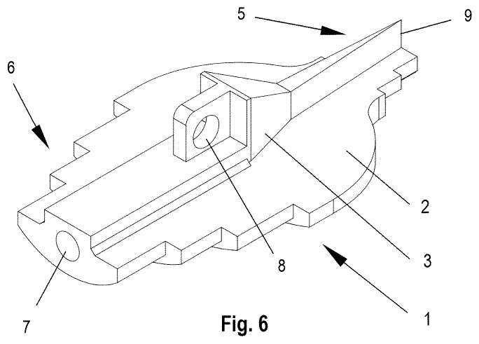

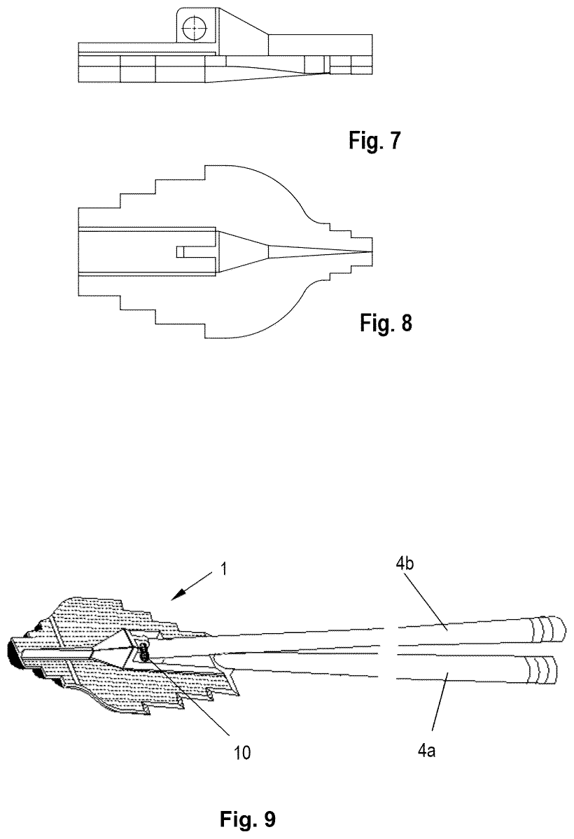

FIG. 6 shows the perspective view of the flat keying anchor. The anchoring part 2 and the connecting part 3 are manufactured as one part from the polymer on the 3D/4D printer. FIG. 7 and FIG. 8 shows the side view and the top view of the keying anchor respectively. FIG. 9 shows the keying anchor from FIGS. 6-8, with the driving part 4. The driving part 4 is made of two members, first member 4a for driving the anchoring part into the ground is entering the blind bore 7, and the second member 4b for pooling out the anchoring part into the anchoring position is connected pivotally to the anchoring part with its hub and a pin 10 passing the through hole 8 and creating the joint. After installing the keying anchor in the desired position in the lunar or Martian regolith, also referred to as lunar soil, under space geotechnical conditions that involve different gravitational forces compared to Earth's, the first member can be left in the lunar soil or can be pulled out and used for installing another keying anchors, and the second member is used for connecting the plate anchor with the external structure.

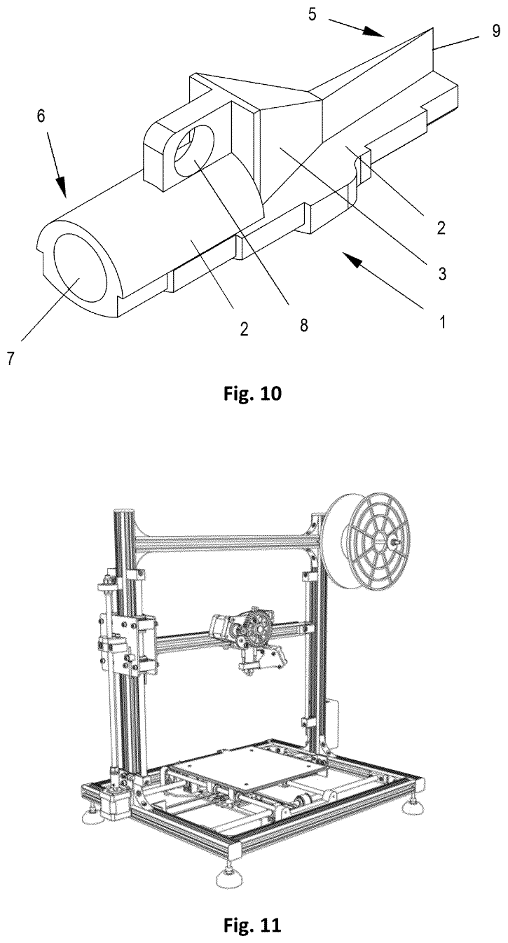

FIG. 10 shows the perspective view of the cylindrical keying anchor which is similar to the flat keying anchor. The difference is the shape of the anchoring part which is essentially cylindrical. The cylindrical keying anchor is comprising at least partially cylindrical elongated anchoring part 2, having a leading end 5 and a trailing end 6, a longitudinal axis extending from the leading end 5 to the trailing end 6 and a through hole 8 provided on the connecting part 3, positioned substantially in the middle between the leading end 5 and the trailing end 6. FIG. 11 shows an example of a 3D/4D printer from prior art for printing with a polymer filament (not claimed).

The polymer space anchors for use on an extraterrestrial body according to this invention can be manufactured according to the specific type, design, shape and the exact required quantity on the construction site on an extraterrestrial body in a short time without delay. It is also possible to use an automatic 3D/4D printers and print the space anchors after working hours, during night or a weekend without any employee service. The polymer material is cheaper than steel and galvanized materials. In a ground water level zones, the polymer space anchors can be used without time limit because they do not corrode, in contrast to the steel or galvanized space anchors. The space anchors were tested in tension (pull out) and compression test laboratory for single and multi-layered the lunar or Martian regolith, also referred to as lunar soil, under space geotechnical conditions that involve different gravitational forces compared to Earth's. The test results were similar to the steel anchors known from the prior art.

What is claimed is:

1. A space anchor (1) specifically designed for extraterrestrial environments in various gravities compared to earth conditions, comprising at least one anchoring part (2) connectable or connected by a connecting part (3) to a driving part (4) for installation in the soil of an extraterrestrial body, such as lunar or Martian regolith as lunar soil, wherein:
the anchoring part (2) and the connecting part (3) are manufactured of a polymer chosen for its lightweight, high strength, and resistance to environmental degradation unique to extraterrestrial conditions, and
the anchoring part (2) is optimized for lunar or Martian soil (regolith) to prevent anchor dislodgement under space conditions.

2. The space anchor according to claim 1, wherein the space anchor is a plate anchor, the anchoring part being a plate (2) connected substantially perpendicular to the driving part (4) by the connecting part (3), and wherein the plate geometry is specifically adapted to maximize surface area contact and stability within loose lunar or Martian soil (regolith).

3. The space anchor according to claim 1, wherein the space anchor is a screw anchor, and the anchoring part (2) is at least a part of a helical screw optimized for lunar or Martian soil (regolith) penetration and load distribution, permanently connected to the driving part (4) by the connecting part (3), wherein the anchoring part (2) and the connecting part (3) are manufactured as a single, homogenous piece.

4. The space anchor according to claim 1, wherein the space anchor is a keying anchor, comprising an elongated anchoring part (2) with a sharp leading part (9) designed to penetrate and stabilize in compacted lunar or Martian soil (regolith), and wherein the anchoring part (2) and the connecting part (3) are manufactured as a single polymeric structure for enhanced integrity and reduced production complexity.

5. The space anchor according to claim 4, wherein the anchoring part (2) is essentially flat, enhancing surface interaction with loose, fine-grained lunar or Martian soil (regolith), thereby improving anchor performance in soft soils.

6. The space anchor according to claim 4, wherein the anchoring part (2) is essentially cylindrical to improve anchoring performance in denser extraterrestrial soils.

7. The space anchor according to claim 1, wherein the polymer includes materials such as Polycarbonate (PC), Nano-Polymers, Bio-Polymers, Nano-Bio Polymers, or combinations thereof, selected for their adaptability and superior mechanical properties in extreme extraterrestrial environments.

8. A method of production of the space anchor according to claim 1, wherein:
the anchoring part (2) and the connecting part (3) are produced on-site on an extraterrestrial body using 3D or 4D printing technologies,
the printing process utilizes a polymer filament specifically engineered for compatibility with lunar or Martian soil (regolith), and
the material formulation includes additives to enhance performance under vacuum, temperature extremes, and radiation exposure.
